(19) United States
(12) Patent Application Publication
(10) Pub. No.: US 2009/0287474 A1
(43) Pub. Date: Nov. 19, 2009

(54) WEB EMBEDDED LANGUAGE INPUT ARRANGEMENT

(75) Inventor: Chien-Hung Zordius CHEN, Taipei (TW)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 12/122,430

(22) Filed: May 16, 2008

(51) Int. Cl. G06F 17/20

(52) U.S. Cl. 704/8

(57) ABSTRACT

In one embodiment of the present invention, a method for accepting input on a web page having a native language is provided. A system causes a web page to be displayed to the user, the web page containing a text input area and a first language object corresponding to a second language other than the native language, wherein the first language object is selectable. A selection is received from a user activating the first language object. A first character input by the user is received, wherein the character input is in the native language. A second character of the second language corresponding to the first character of the native language is located. The system then causes the second character to be inserted in the text input area in lieu of inserting the first character in the text input area

### BACKGROUND

When international and other foreign-language travelers move from one place to another and use computers not having their native language capability installed, it can be difficult for the travelers to access various Internet functions such as searching the World Wide Web. While many computer programs, including web browsers, allow for the installation of language packs enabling the application to operate in a foreign language, this solution presents a number of significant drawbacks.

First, installing a language pack takes up space on the computer. Language packs can sometimes be quite large, especially when dealing with languages with their own alphabets, as new fonts and subroutines are often included in the language packs. While some computers may have plenty of available space for such installations, the rise in use of mobile devices such as cell phones and hand-held computers to navigate the Internet has created a class of memory-limited devices being used for web browsing. Clearly use of large language packs creates difficulty on such devices.

Second, utilizing a language pack can take up additional processing power. Like with memory space, certain devices such as cell phones and hand-held computers may have limited processing power, and thus reducing the workload on the processors of such devices is desirable.

Third, installing a language pack may not be feasible for security reasons. A number of computers restrict or prohibit the installation of additional applications/modules. For example, company-owned computers often prohibit anyone not having administrator rights installing applications/modules. Additionally, computers operated in public places, such as web cafes, also often prohibit such installations. As such, there are circumstances where the user may be in a situation where installing a language pack is not even possible.

Fourth, installing a language pack may be difficult for a user who is not familiar with the language currently utilized by the computer. Clearly, since the user wants to install the language pack, it would be quite common that the user would not be familiar with the language operating on the computer. For example, a tourist from Japan who doesn't understand English would have a difficult time installing a language pack on a computer having only English installed, as the user would be unable to read screen prompts to understand how to modify the settings of the application to install the Japanese language pack. While the user may be able to engage in simple and language-independent tasks such as opening a web browser, the act of installing a language pack may be too difficult when the installation process is in not in the user's native tongue.

### SUMMARY

In one embodiment of the present invention, a method for accepting input on a web page having a native language is provided. A system causes a web page to be displayed to the user, the web page containing a text input area and a first language object corresponding to a second language other than the native language, wherein the first language object is selectable. A selection is received from a user activating the first language object. A first character input by the user is received, wherein the character input is in the native language. A second character of the second language corresponding to the first character of the native language is located. The system then causes the second character to be inserted in the text input area in lieu of inserting the first character in the text input area

In another embodiment of the present invention, a system is provided comprising: one or more client devices; and a server configured to: cause a web page to be displayed to the user, the web page containing a text input area and a first language object corresponding to a second language other than the native language, wherein the first language object is selectable; receive a selection from a user activating the first language object; receive a first character input by the user, wherein the character input is in the native language; locate a second character of the second language corresponding to the first character of the native language; and cause the second character to be inserted in the text input area in lieu of inserting the first character in the text input area.

In another embodiment of the present invention, an apparatus for accepting input on a web page having a native language is provided, the apparatus comprising: means for causing a web page to be displayed to the user, the web page containing a text input area and a first language object corresponding to a second language other than the native language, wherein the first language object is selectable; means for receiving a selection from a user activating the first language object; means for receiving a first character input by the user, wherein the character input is in the native language; means for locating a second character of the second language corresponding to the first character of the native language; and means for causing the second character to be inserted in the text input area in lieu of inserting the first character in the text input area.

In another embodiment of the present invention, a program storage device is provided tangibly embodying a set of computer instructions to perform a method for accepting input on a web page having a native language, the method comprising: causing a web page to be displayed to the user, the web page containing a text input area and a first language object corresponding to a second language other than the native language, wherein the first language object is selectable; receiving a selection from a user activating the first language object; receiving a first character input by the user, wherein the character input is in the native language; locating a second character of the second language corresponding to the first character of the native language; and causing the second character to be inserted in the text input area in lieu of inserting the first character in the text input area.

### BRIEF DESCRIPTION OF THE DRAWINGS

FIG. 1 is an example of how a Chinese keyboard as is commonly used.

FIG. 2 is a diagram illustrating an example web page in accordance with an embodiment of the present invention.

FIGS. 3-9 are diagrams illustrating an example of typing a Chinese word using an embodiment of the present invention.

FIGS. 10-14 are diagrams illustrating an example of typing a Japanese word using an embodiment of the present invention.

FIG. 15 is a flow diagram illustrating a method for accepting input on a web page having a native language in accordance with an embodiment of the present invention.

FIG. 16 is an exemplary network diagram illustrating some of the platforms that may be employed with various embodiments of the invention.

### DETAILED DESCRIPTION OF EMBODIMENTS OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention takes advantage of the fact that many international countries utilize an English-style keyboard. As such, despite vast language differences between most major countries, most people are familiar with the layout of the English-style keyboard. Indeed, in many countries, each key of the keyboard contains the common English letter corresponding to that key along with the letter of the user's language.

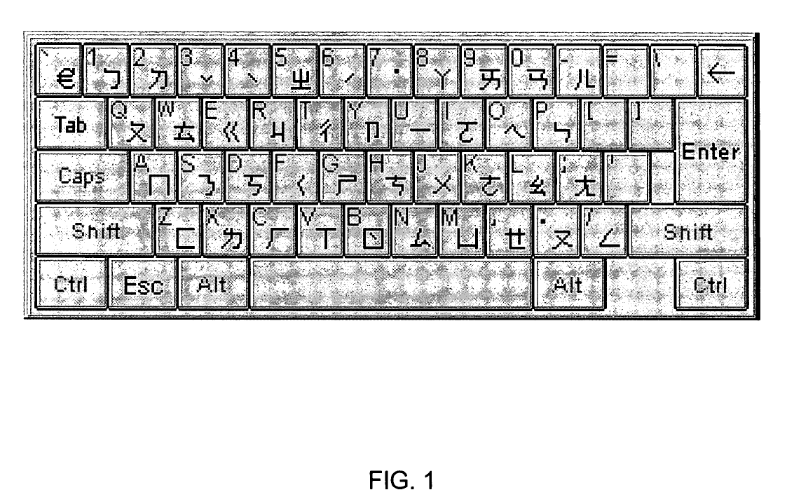

FIG. 1 is an example of how a Chinese keyboard as is commonly used. As can be seen, the keyboard contains both Chinese and English language. Chinese users are familiar with the fact that pressing certain keys on the English keyboard means to pronounce the Chinese phonetic corresponding to that key. By pressing a series of keys followed by a finish symbol, the user can create a pronunciation train for the words the user wishes to input.

In an embodiment of the present invention, a button or other selectable object is provided on a web page enabling the user to switch between input languages. By depressing the button or otherwise selecting the object, any inputs the user types on the web page are automatically input as the language selected instead of the native language of the web page.

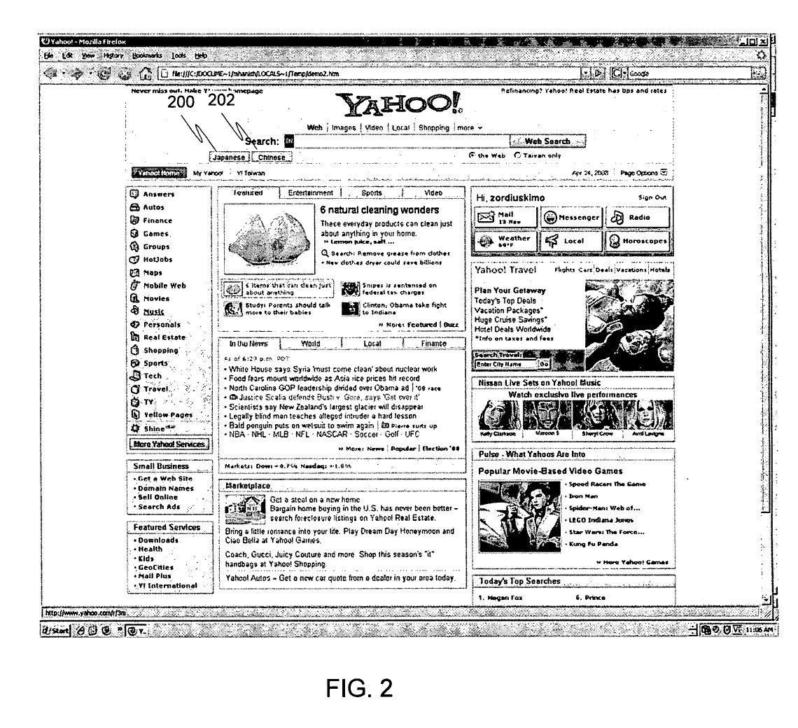

FIG. 2 is a diagram illustrating an example web page in accordance with an embodiment of the present invention. As can be seen, the web page appears to be a standard English-language search engine page. However, buttons 200 and 202 have been added, which allow the user to change the input language to the selected language.

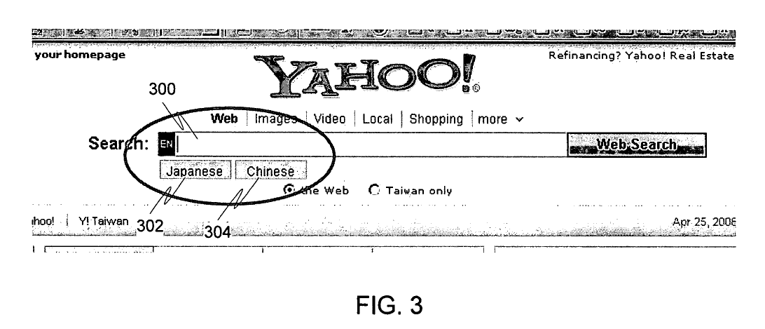

FIGS. 3-9 are diagrams illustrating an example of typing a Chinese word using an embodiment of the present invention. In FIG. 3, the input box 300 is blank. Buttons for Japanese 302 and Chinese 304 are provided.

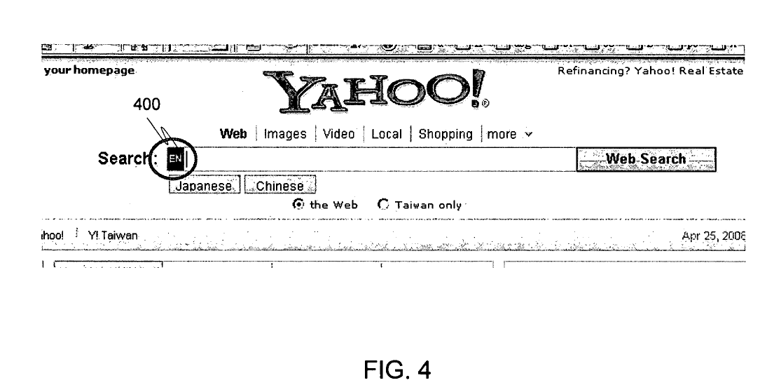

In FIG. 4, an indicator 400 informs the user the language of the input mode. Here, the mode is English.

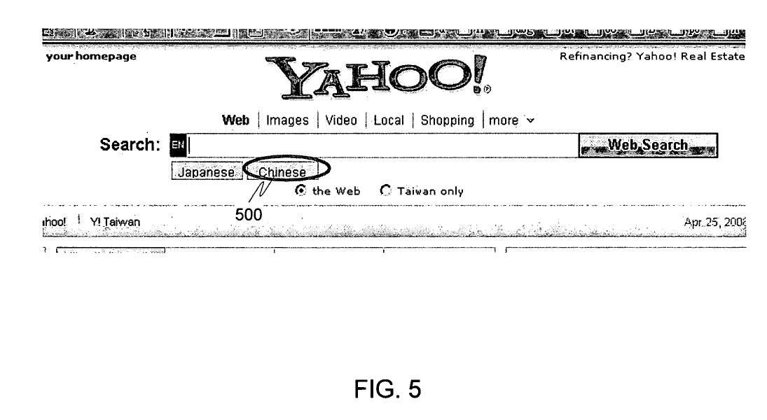

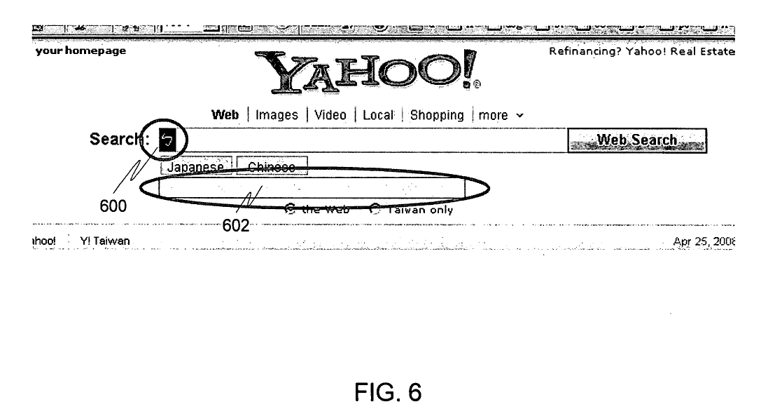

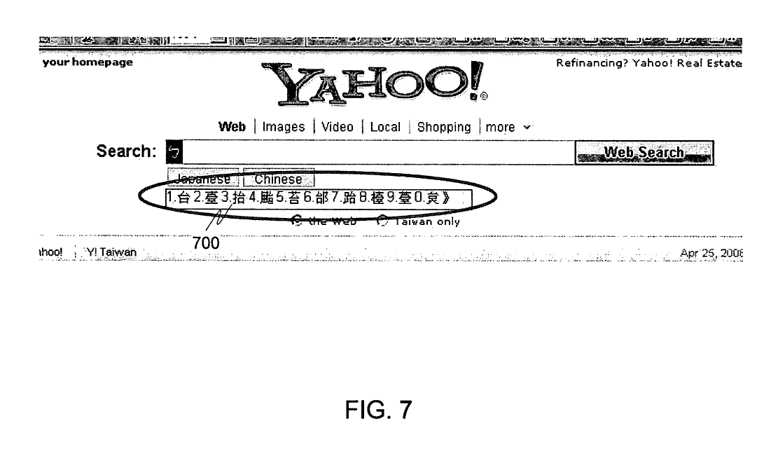

Suppose now that a Chinese-speaking user wishes to conduct a search on “Taiwan”. He may open the browser to the English web page described above, then click on the Chinese 500 button, as can be seen in FIG. 5. In FIG. 6, the indicator 600 has changed to indicate that the input mode is now Chinese. In one embodiment of the present invention, a status bar 602 may appear to inform the user of the mapping of certain keys (possibly frequently used characters with the same pronunciation) to Chinese. This mapping 700 may be seen in FIG. 7. This may be helpful for users who have trouble remembering which keys correspond to which Chinese characters (since the keyboard being used likely would not show any characters other than English characters). Alternatively, some other type of mapping may be provided to the user. For example, the user may carry a physical overlay that can be placed on a keyboard when traveling that reminds the user of the mapping between keys.

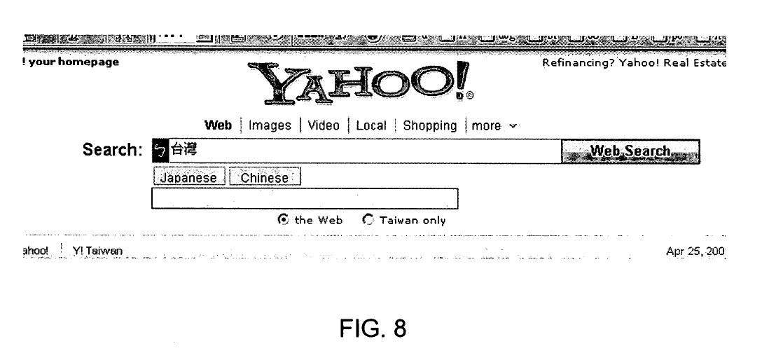

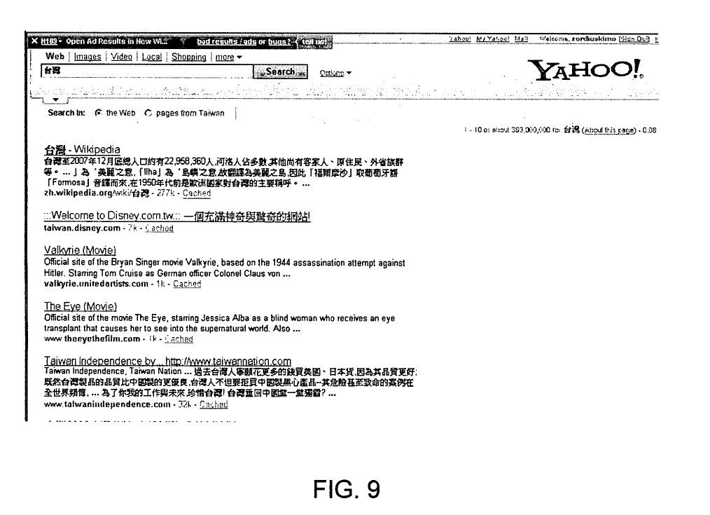

The user may then input a Chinese word 800 by typing the corresponding keys on the keyboard, as can be seen in FIG. 8. The user may then finish the input by pressing “web search”. The results of the search may be seen in FIG. 9.

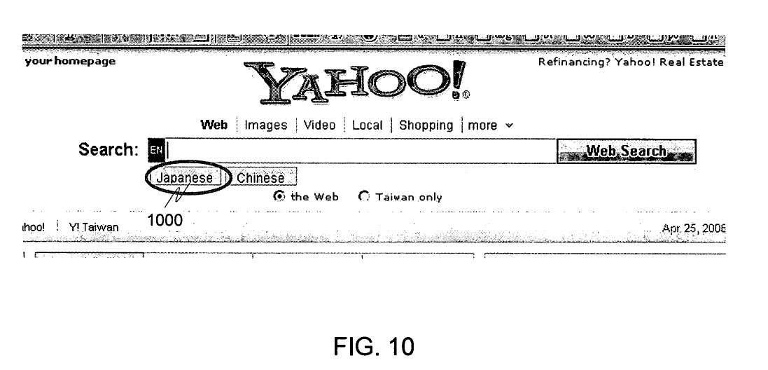

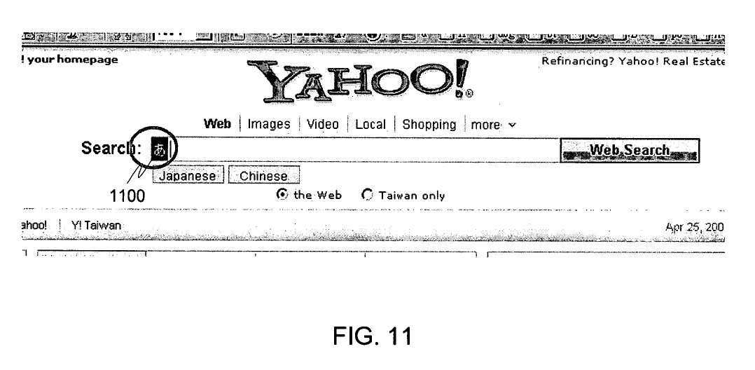

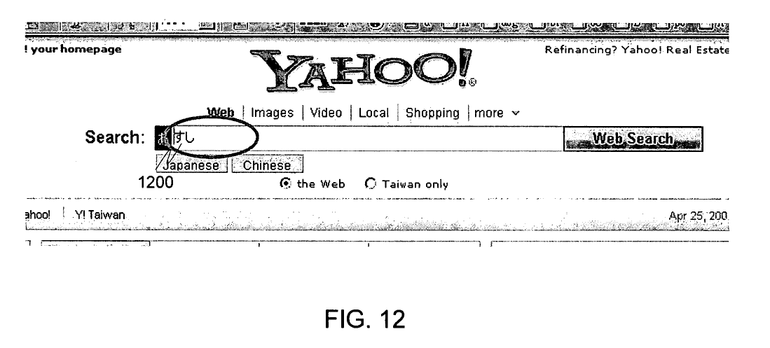

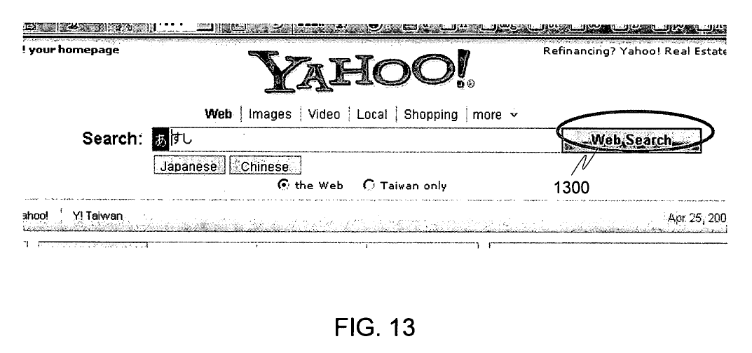

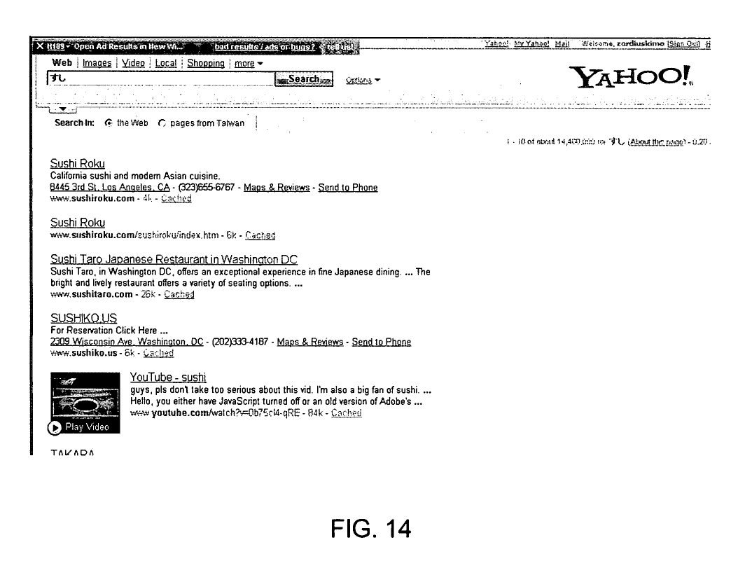

Another example is provided in FIGS. 10-14 showing the user selecting a Japanese input. In FIG. 10, the user may select the Japanese button 1000. The indicator 1100 may then change in FIG. 11 informing the user that they are now in Japanese input mode. The user may then type that Japanese characters 1200 into the input box as seen in FIG. 12, and press the “web search” button 1300 in FIG. 13. This results in a search on Sushi (in Japanese, pronounced “Susi”), as can be seen in FIG. 14.

It should be noted that the above embodiments assume that the database being searched is still the database native to the language of the original web page. In other words, for example, a Japanese user typing in Japanese characters in the input box is still searching the U.S. database for the words. In an alternative embodiment of the present invention, selecting a language by using the button (e.g., hitting the Japanese or Chinese button) may result in the web page altering the execution so that a different database is searched or different actions occur. For example, hitting the Japanese may not only change the input language to Japanese, but also alter the database being searched to the Japanese database. Of course, this may not be desirable in certain circumstances. For example, a foreign visitor to the United States searching for food like sushi is likely attempting to locate sushi places near where they currently are (in the United States), and thus transferring the request to a Japanese database would defeat the purpose of the search. As such, this option may be eliminated or made selectable in many instances.

Furthermore, it is also noted that the native language of the web page has not changed. As can be seen in FIG. 2, the display characters such as headline 204 are still in English. In one embodiment, selecting a language button not only changes the input language but also alters the output or display language. For example, clicking the Japanese button may act to refresh the web page so that the text is in Japanese. There may be cases where the web page supports multiple languages (for example, the web page may be written with translations into multiple languages). Alternatively, automatic translation programs may be utilized when the user selects the button to transform the display into the desired language.

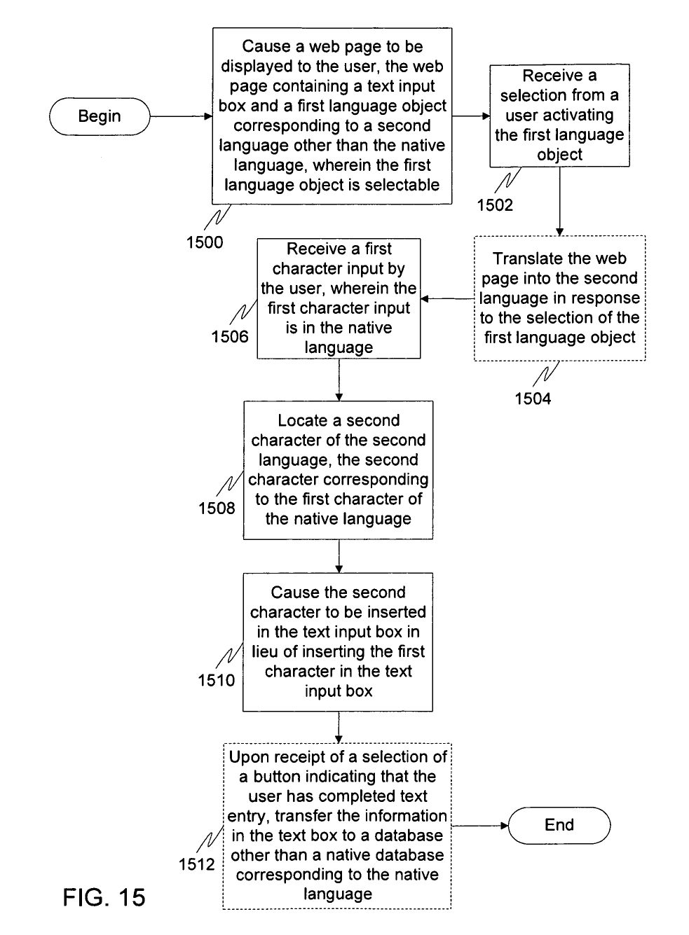

FIG. 15 is a flow diagram illustrating a method for accepting input on a web page having a native language in accordance with an embodiment of the present invention. Each step in this method may be embodied in hardware, software, or any combination thereof. The method may be executed on, for example, a server that is coupled via a network to one or more client computing devices, and the input may be received from one of the client computing devices that a user is operating.

At 1500, the system causes a web page to be displayed to the user, the web page containing a text input area and a first language object corresponding to a second language other than the native language, wherein the first language object is selectable. By selectable, it is meant that the object, when displayed to the user, can be selected by the user with a user interface, such as by moving a mouse cursor over the object and clicking a mouse button, or via other types of input. In one embodiment, the first language object is a button. If the method is being run on a device other than the one the user is utilizing (such as running on a server), then the device might not have the ability to directly display the web page to the user. Hence, the phrase “causing a web page to be displayed to the user” shall be interpreted to include indirectly causing a web page to be displayed, such as where the server sends the web page to a client device in order that the client device can display the web page to the user.

At 1502, a selection is received from a user activating the first language object. Here, the user has selected the object, such as by clicking the mouse button while the mouse cursor is over the object. As with step 1500, this step may be performed indirectly in that the selection may not be directly received from the user but may be received by a server from a client device, wherein the client device had received the selection from the user.

At 1504, an optional step may be performed where the web page is translated into the second language in response to the selection of the first language button.

At 1506, a first character input by the user is received, wherein the first character input is in the native language. By “in the native language”, it is meant that the user has selected one or more keys that would ordinarily cause input in the text box in the native language. It is not necessary that the characters inputted actually cause characters in the native language to be displayed. In fact, in many embodiments, it is preferable not to display the characters in the native language as subsequent steps will be displaying the corresponding characters in a different language. Additionally, as with the previous steps, there is no necessity that step 1506 be performed directly. The character inputted may be received by a server from a client device, wherein the client device had received the input from the user.

At 1508, a second character of the second language may be located, the second character corresponding to the first character of the native language. This may include, for example, examining a mapping between characters of the native language and characters of the second language.

At 1510, the system may cause the second character to be inserted in the text input area in lieu of inserting the first character in the text input area. As with steps above, this step may be performed indirectly in that a server may send a signal to a client device to insert the character in the text box. By inserting the second character in lieu of the first character, the system has essentially replaced the native language character with a non-native language character.

At 1512, an optional step may be performed where, upon receipt of a selection of a button indicating that the user has completed text entry, the information in the text box may be transferred to a database other than a native database corresponding to the native language. This, for example, might include sending the information to a Japanese database instead of an English database when the “web search” button is depressed.

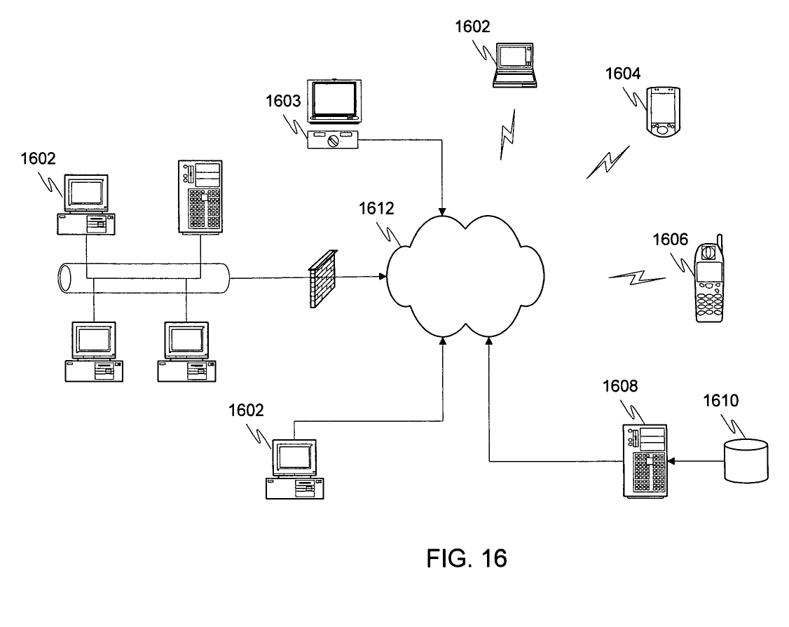

It should also be noted that embodiments of the present invention may be implemented on any computing platform and in any network topology in which presentation of search results is a useful functionality. For example and as illustrated in FIG. 16, implementations are contemplated in which the invention is implemented in a network containing personal computers 1602, media computing platforms 1603 (e.g., cable and satellite set top boxes with navigation and recording capabilities (e.g., Tivo)), handheld computing devices (e.g., PDAs) 1604, cell phones 1606, or any other type of portable communication platform. Users of these devices may navigate the network and enter input in response to the displaying of captcha on local displays, and this information may be collected by server 1608. Server 1608 (or any of a variety of computing platforms) may include a memory, a processor, and a communications component and may then utilize the various techniques described above. The processor of the server 1608 may be configured to run, for example, all of the processes described in FIG. 15. Any of the client devices 1602, 1603, 1604, 1606 may be alternatively be configured to run, for example, some or all of the processes described in FIG. 15. Server 1608 may be coupled to a memory 1610, which may store the mappings between languages. Applications may be resident on such devices, e.g., as part of a browser or other application, or be served up from a remote site, e.g., in a Web page (also represented by server 1608 and memory 1610). The invention may also be practiced in a wide variety of network environments (represented by network 1612), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for accepting input on a web page having a native language, the method comprising:
causing a web page to be displayed to the user, the web page containing a text input area and a first language object corresponding to a second language other than the native language, wherein the first language object is selectable;
receiving a selection from a user activating the first language object;
receiving a first character input by the user, wherein the character input is in the native language;
locating a second character of the second language corresponding to the first character of the native language; and
causing the second character to be inserted in the text input area in lieu of inserting the first character in the text input area.

2. The method of claim 1, wherein the locating includes examining a mapping between characters of the native language and characters of the second language.

3. The method of claim 1, wherein the object is a button and the selection is a user click of the button.

4. The method of claim 1, wherein the web page further comprises a second language object corresponding to a third language other than the native language.

5. The method of claim 1, further comprising translating the web page into the second language in response to the selection of the first language button.

6. The method of claim 1, further comprising, upon receipt of a selection of a button indicating that the user has completed text entry, transferring the information in the text box to a database other than a native database corresponding to the native language.

7. A system comprising:
one or more client devices; and
a server configured to:
cause a web page to be displayed to the user, the web page containing a text input area and a first language object corresponding to a second language other than the native language, wherein the first language object is selectable;
receive a selection from a user activating the first language object;
receive a first character input by the user, wherein the character input is in the native language;
locate a second character of the second language corresponding to the first character of the native language; and
cause the second character to be inserted in the text input area in lieu of inserting the first character in the text input area.

8. The system of claim 7, wherein at least one of the client devices is a mobile phone.

9. The system of claim 7, wherein the server further contains a memory storing a mapping between characters of the native language and characters of the second language.

10. An apparatus for accepting input on a web page having a native language, the apparatus comprising:
means for causing a web page to be displayed to the user, the web page containing a text input area and a first language object corresponding to a second language other than the native language, wherein the first language object is selectable;
means for receiving a selection from a user activating the first language object;
means for receiving a first character input by the user, wherein the character input is in the native language;
means for locating a second character of the second language corresponding to the first character of the native language; and
means for causing the second character to be inserted in the text input area in lieu of inserting the first character in the text input area.

11. The apparatus of claim 10, wherein the means for locating includes means for examining a mapping between characters of the native language and characters of the second language.

12. The apparatus of claim 10, wherein the object is a button and the selection is a user click of the button.

13. The apparatus of claim 10, wherein the web page further comprises a second language object corresponding to a third language other than the native language.

14. The apparatus of claim 10, further comprising means for translating the web page into the second language in response to the selection of the first language button.

15. The apparatus of claim 10, further comprising means for, upon receipt of a selection of a button indicating that the user has completed text entry, transferring the information in the text box to a database other than a native database corresponding to the native language.

16. A program storage device tangibly embodying a set of computer instructions to perform a method for accepting input on a web page having a native language, the method comprising:
causing a web page to be displayed to the user, the web page containing a text input area and a first language object corresponding to a second language other than the native language, wherein the first language object is selectable;
receiving a selection from a user activating the first language object;
receiving a first character input by the user, wherein the character input is in the native language;
locating a second character of the second language corresponding to the first character of the native language; and
causing the second character to be inserted in the text input area in lieu of inserting the first character in the text input area.
